(19) United States
(12) Patent Application Publication
(10) Pub. No.: US 2003/0055877 A1
(43) Pub. Date: Mar. 20, 2003

(54) Remote client manager that facilitates an extendible, modular application server system distributed via an electronic data network and method of distributing same

(76) Inventors: Damon Williams, Austin, TX (US); Daniel Solano, Austin, TX (US)

Correspondence Address: Erik B. Cherdak & Associates, LLC, 11300 Rockville Pike, Suite 906, Rockville, MD, 20852, US

(21) Appl. No.: 09/951,888

(22) Filed: Sep. 14, 2001

(51) Int. Cl. G06F 15/16; G06F 9/44

(52) U.S. Cl. 709/203; 709/315

(57) ABSTRACT

A remote client manager that facilitates an extendible, modular application server system distributed via an electronic data network, that includes: a network client, a remote client facility and a lease manager. The network client is configured to access the application server system via the electronic data network and to download and execute an interface facility (JAVA applet, etc.). The interface facility is configured to facilitate the delivery of an application facility from the application server system. The remote client facility is configured to register the network client, the interface facility, and the application facility, to receive an application request from the interface facility via the electronic data network related to the application facility, and to reference the network client to the application facility to facilitate the delivery of the application facility to the network client. And, the lease manager is configured to create a lease (e.g., a network object, database entry, etc.) corresponding to the reference and to terminate the lease when a time interval related to the lease expires.

### BACKGROUND OF THE INVENTION

1. Field of the Invention

The present invention relates to systems and methods for serving computer applications. More particularly, the present invention relates to systems and methods for managing remote clients and applications served thereto within a middle-tier application framework that is extendible and modular.

2. Description of the Related Art

Commercial use of the Internet has increased both in kind and magnitude. The popularity of the Internet and World Wide Web (WWW) in commerce has made network computing increasingly more important in today's environment. Many companies are making information available to the public over the Internet that has been previously unavailable. More and more companies are tying their core business systems to the Internet. And, whole industries have sprung up to support Internet commerce.

Delivering rich content to customers is of utmost importance in such a competitive market. As companies rely more and more on the Internet to perform core business functions, content providers on the Internet have had to find new ways to deliver customized interfaces and web sites (e.g., customized “look and feel,” functionality, etc.) in order to properly support the changing requirements of their customers. Additionally, content providers are often required to maintain and provide the same or similar data to multiple customers in multiple interfaces based on such requirements.

Another important function in today's environment is localization, or internationalization. The Internet by its nature provides companies that otherwise would be unable to compete internationally, an easy way to access international markets and offer their services. Accordingly, Internet content providers may serve international customers that require that their content be provided in specific formats or languages depending on their locale (e.g., in Spanish, etc.). Thus, in order to be competitive internationally, content providers must also localize their content for their for customers.

Furthermore, Internet commerce moves at a rate that is substantially faster than the “old economy.” Accordingly, web sites are deployed at an incredible rate, and customers expect web designers to provide reliable integrated web applications quickly and inexpensively.

Accordingly, content and application providers on the Internet are developing and hosting enhanced web applications to fulfill their customers needs. However, hosting such applications has become more difficult because of the aforementioned issues and developments. For example, customers may require constant modifications, such as adding new functions or modifying current ones, to keep up with competitors or to fulfill their customers need, etc. Rapid development of enhanced web applications and modifications thereto cause many problems maintaining and serving such applications.

One problem that content and application providers encounter is maintaining a level of availability (i.e., a low amount of downtime). As modifications are made to applications, such as modules being added and modified, often an application must be entirely shut down so that the new version of the application may be loaded, or alternatively, portions of an application might necessarily be shut down until the new portion is loaded. However, many customers require “24 by 7” coverage, and the constant shutdowns, no matter how brief, can significantly hinder the amount uptime.

Another problem application and content providers encounter relates to maintaining such web applications. As modules within an application are added and modified, versions of the same tend to get out of sync with one another, and often errors occur in an application because a shared module has been updated without updating other dependent modules, or alternatively, duplicative modules are often updated piecemeal, such that modules that perform the same or similar functions become out of sync and begin to perform inconsistently with one another because of bad version control. Furthermore, business to business solutions (B2B) often require sharing or linking data, modules, web sites, etc. between distinct business entities, which exacerbates compatibility and maintenance issues because, often in B2B applications, software modules are distributed across a number of separate network devices owned and maintained by separate business entities.

Another problem content and application providers find relates to rapid development. Often, in the current business environment, a company's success depends in a large part on its ability to be first to the market with a product, innovation, etc. Therefore, rapid development and modification of enhanced web applications is extremely important to many such companies. However, large and complex programs are often difficult to develop quickly without significantly reducing the quality of such programs. And, such applications often require many of standard functions, such as credit card validation, data entry, security, etc. Therefore, in order to rapidly develop and modify enhanced web applications, developers wish to take advantage of common functions by sharing them between applications and modular designs that allow the same.

Thus, there exists a need to provide new and improved systems and methods of serving enhanced web applications to solve the aforementioned problems. Application server systems should be extendible and support modular application design, localization, applications that may be distributed across an electronic data network, and that are dynamically updateable. Accordingly, also needed are new and improved systems and methods for managing remote clients within such modular application frameworks. Such systems and methods should provide access to distributed applications to multiple remote clients while ensuring adequate version control, security, etc., and should be programmed using modern object oriented methodologies and technologies.

The present invention squarely addresses the aforementioned problems and needs and delivers such new and improved systems and methods which are described in detail below.

### SUMMARY OF THE INVENTION

The present invention solves the aforementioned problems and provides new and improved systems and methods delivering distributed appellations via an electronic data network, such as the Internet and World Wide Web. Furthermore, the present invention provides for managing remote network clients within an application server system that is extendible and distributable. The present invention provides for modular design and novel ways of managing and sharing modules (i.e., system components, services, servants, daemons, facilities, etc.).

Many benefits will be appreciated from the present invention. For example, the modular design allows many applications distributed across a network or networks (the Internet and WWW), to share modules of code and facilities, thus improving maintainability, extendibility, efficiencies of scale, etc. Furthermore, the present invention provides version control and system component management that improves availability and allows for easy updating of code without shutting down corresponding modules in use, for example.

The present invention solves the aforementioned problems and provides the above-stated benefits by providing new and improved systems and methods for managing remote clients within an application server system that is extendible and modular, and is distributed across an electronic data network. According to a preferred embodiment of the present invention, provided is a remote client manager that facilitates an extendible, modular application server system distributed via an electronic data network, that includes a network client, a remote client facility and a lease manager. The network client is configured to access the application server system via the electronic data network and to download and execute an interface facility (JAVA applet, etc.). The interface facility is configured to facilitate the delivery of an application facility from the application server system. The remote client facility is configured to register the network client, the interface facility, and the application facility, to receive an application request from the interface facility via the electronic data network related to the application facility, and to reference the network client to the application facility to facilitate the delivery of the application facility to the network client. And, the lease manager is configured to create a lease (e.g., a network object, database entry, etc.) corresponding to the reference and to terminate the lease when a time interval related to the lease expires.

And, according to another preferred embodiment of the present invention, provided is a method for managing application delivery to a remote network client, comprising the steps of: at a remote client manager residing on a server facility, registering an application facility and assigning the application facility a first unique identifier; next, at the remote client manager, exporting the application facility to a port of the server facility; next, at the remote network client, accessing the server facility to download and execute an interface facility. The interface facility is configured to communicate with the remote client manager. Next, at the interface facility, registering with the remote client manager and requesting said application facility; next, at the remote client manager, checking the IP address of the remote network client against a secure list and performing a call back to the remote network client; next, at the remote client manager, if the call back is successful, assigning a second unique identifier to the remote network client and creating a reference from the remote network client to the application facility based on the first and second unique identifiers; next, at a lease manager residing on the server facility, creating a lease object having an expiration related to the reference; and, at the lease manager, monitoring the lease object and terminating the reference at the expiration of the lease object.

### BRIEF DESCRIPTION OF THE DRAWING FIGURES

The present invention is described in detail below with reference to the attached drawing figures, of which:

FIG. 1 is a block diagram of a remote client manager within an extendible, modular application server system that is distributed across an electronic data network in accordance with a preferred embodiment of the present invention;

FIG. 2 is a logical diagram of an exemplary remote client manager that facilitates an application server system that is extendible and modular, and is distributed across an electronic data network in accordance with a preferred embodiment of the present invention;

FIG. 3 is a block diagram of a data processing system that may be used to implement a system for generating a customized web interface via an electronic data network in accordance with a preferred embodiment of the present invention; and

FIG. 4 is flow chart of a method for managing a remote client while distributing and serving enhanced web applications to that client via an electronic data network in accordance with a preferred embodiment of the present invention.

### DETAILED DESCRIPTION OF THE PREFERRED EMBODIMENTS

Now, salient features of the present invention are discussed in detail with regard to the attached drawing figures which were briefly described above. Unless otherwise indicated, like parts and processes are referred to with like reference numerals.

For the purposes of the following discussions, the following terms are intended to have the following means:

A service is any computer program, module or the like, that communicates with a network client outside an application server system and provides a valuable business function (e.g., a module of an enhanced web application, etc).

A daemon is an internal computer program, module or the like, that performs a basic or common function and does not communicate directly with a network client. Daemons are typically called by services or other daemons.

A facility is a system component (e.g., program, server system, service, daemon, etc.) that may be hardware, software or a combination thereof.

A servant is a modular piece of code which runs within an application server system framework. For example, a servant may be an object in an object oriented framework, a JAVA servant, servlet, program, etc.

### Application Server Framework

This patent application is based in part on technologies and methodologies described in co-owned, co-pending U.S. patent application Ser. No. “______”, entitled “MODULAR, EXTENSIBLE APPLICATION SERVER THAT IS DISTRIBUTED ACROSS AN ELECTRONIC DATA NETWORK AND METHOD OF MAKING SAME,” filed on ______, 2000, and Ser. No. “______”, entitled “SYSTEM AND METHOD FOR GENERATING DYNAMIC WEB INTERFACES THAT ARE CUSTOMIZED AND LOCALIZED,” filed on ______, 2000, and are hereby incorporated by reference. The former patent application describes an extendible, distributed system for serving modular applications, such as enhanced web applications via an electronic data network, and methods for performing the same, and should be referred to for the purpose of disclosing an application server system in which the present invention will reside and facilitate, and version control and management of modules within the same. The later patent application describes an application framework for providing custom web interfaces and enhanced web applications that are dynamically generated and may be facilitated by the present invention in accordance with a preferred embodiment thereof. And, that patent document should be referred to for the purpose of disclosing technologies (i.e., programs, facilities, interfaces, frameworks, etc.), methodologies related to that framework and system and methods generating of dynamic web interfaces and enhanced web applications that are customized and localized.

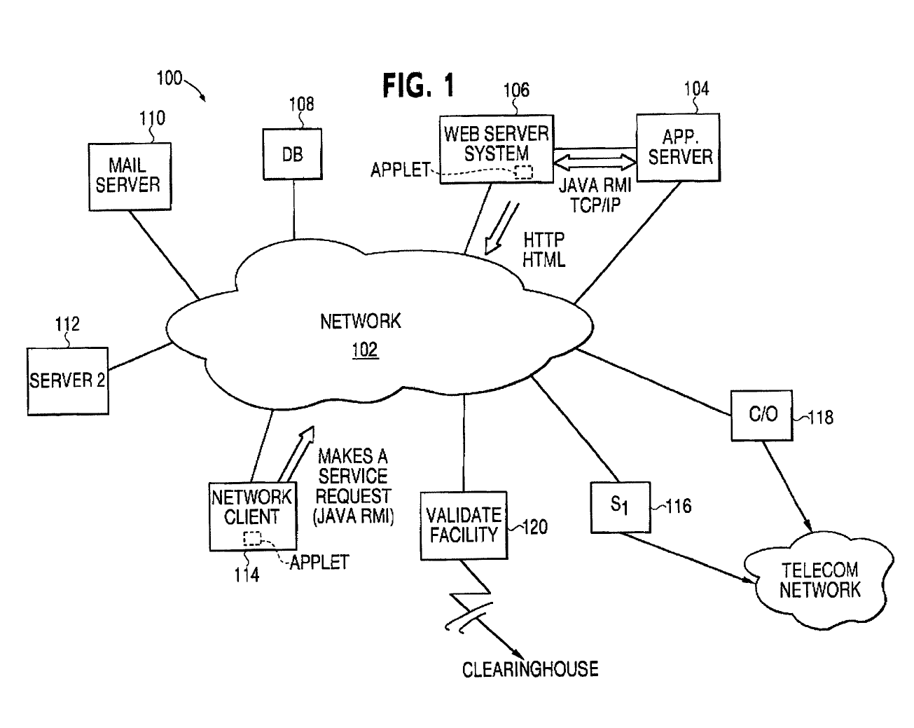

Referring now to FIG. 1, depicted therein is a block diagram of an extendible, modular application server system that is distributed across an electronic data network and utilizes a remote client manager in accordance with a preferred embodiment of the present invention. In particular, system 100 includes an electronic data network 102, which may include the Internet and World Wide Web (WWW), and numerous network facilities including: an application server facility 104, a web server facility 106, and a network client 114. In a typical arrangement, application server facility 104, web server facility 106 and network client 114 are connected to the network (Internet and WWW) 102 in conventional fashion (e.g., modem, ISP, ISDN, etc.).

Application server facility 104, web server facility 106, and network client 114 are configured to work together to facilitate and manage the delivery of applications, such as enhanced web applications, to network client 114. Applications may be distributed across and utilize many network resources such as application server facility 104, web server facility 106, and network client 114, as well as a database facility 108, a mail server 110, another server facility 112, and telecommunications devices switch 116 and central office 118, and validation facility 120. It will be readily understood by one having ordinary skill in the art that various types of modular applications may be distributed across and utilize many other network resources after reviewing this patent document and all its attachments.

Application server facility 104 may be any robust application server that serves as the central processing unit of the present invention in accordance with a preferred embodiment. Preferably, application server facility 104 is a conventional business server system, such as a Hewlett Packard L Class Server running an HP-UX operating system configured to run a JAVA based server system, to store and to serve files (such as JAR files, application files and facilities, etc.) via network 102, and to communicate with other network facilities (e.g., via HTTP, TCP/IP, JAVA RMI, etc.). Accordingly, such a server system may be outfitted appropriately with runtime engines, compilers, etc., in order to facilitate system 100 in accordance with a preferred embodiment of the present invention.

Web server facility 106 may be any conventional web server coupled to the network (Internet and WWW) 102, connected to database facility 106 and configured to store and to serve files (HTML, XML, CSS, XLS and JAR files, JAVA applets, servlets and programs, etc.), to communicate with other network facilities (e.g., via HTTP, TCP/IP, JAVA RMI, etc.), and to execute programs and interfaces that facilitate the present invention. Accordingly, web server facility 106 can be any server system with a commercially available web server system installed, such as APACHE or IPLANET WEB SERVER, and may be appropriately outfitted to execute programs written and designed in commonly used languages such as JAVA, C++, etc., and therefore, may be outfitted with runtime engines and compilers to execute JAVA programs, applets, servlets, C++ programs, etc.

Database facility 108 may be a separate database server or, alternatively, may be a database engine running on application server facility 104, web server facility 106, or any other hardware device coupled to network 102 and configured to execute a database engine. Database facility 108 may also include any utilities, compilers, runtime engines, programs, etc. to facilitate the present invention in accordance with a preferred embodiment. Database server 108 may utilize any well known database engine, such as ORACLE 81 manufactured and marketed by ORACLE CORP., along with appropriate utilities, API's, etc. necessary to facilitate the present invention.

Network client 114 may be a web client coupled to the network (Internet and WWW) 102 (e.g., via ISDN, wireless modem, modem, DSL, etc.) and configured to run a web browser capable of accessing a URL to download and manifest a web page or interface, JAVA program or applet, or other computer programs according to a preferred embodiment of the present invention. For example, network client 114 may be a properly outfitted commercially available personal computer (PC) running a standard windows based operating system, such as WINDOWS 2000 manufactured and marketed by MICROSOFT CORP., and a web browser, such as NETSCAPE NAVIGATOR manufactured and marketed by NESCAPE COMMUNICATIONS CORP. Additional utilities, API's, plug-ins, etc. also may be installed on network client 114 in order to facilitate the present invention in accordance with a preferred embodiment. Alternatively, network client 114 could be any network facility couple to network 102 and configured to interface with other network facilities within system 100, and in particular, wth a remote client facility (described later in this patent document) to make a service or application request. For example, an external application module executing on a remote computer processor within a JAVA Virtual Machine (JVM) may communicate (e.g., make a call via JAVA RMI, etc.) with application server facility 104 to request some sort of service (e.g., application module, a JAVA servant, etc.).

Switch 116 and central office 118 are well known components of a telecommunication network and may be incorporated into system 100 to implement distributed applications related to providing telecommunications services.

The operations of an interface facility (not shown) that may be used to communicate with and control Switch 116, central office 118, and other disparate telecommunications devices are illustrated and described in detail in co-owned, co-pending U.S. patent application Ser. No. 09/414,668 entitled “SYSTEM AND METHOD FOR COMMUNICATING WITH AND CONTROLLING DISPARATE TELECOMMUNICATIONS DEVICES IN A TELECOMMUNICATIONS NETWORK,” filed on Oct. 7, 1999, which is incorporated herein by reference. Accordingly, the reader of this patent document should refer to the aforementioned co-owned, co-pending U.S. patent application for complete disclosure details related to the operations of an interfacing facility in the context of serving and implementing an enhanced web application that provides telecommunications services utilizing disparate telecommunications devices in accordance with the present invention.

Validation facility 120 may be incorporated into system 100 to implement distributed applications that require e-commerce capabilities and to validate credit card transactions, such as by connecting to a clearing authority and the like, or in the case of a telecommunications application, to validate a call (i.e., calling card call, credit card calls, etc.). An example of such a validation facility is disclosed and described in co-owned and co-pending U.S. patent application Ser. No. “________”, entitled “SYSTEM AND METHOD FOR VALIDATING CALLS WITHIN A TELECOMMUNICATIONS NETWORK” filed on May 31, 2000, and is hereby incorporated by reference. Accordingly, the reader of this patent document should refer to the aforementioned co-owned, co-pending U.S. patent application for complete disclosure details related to the operations of a validation facility in the context of serving and implementing an enhanced web application that provides e-commerce capabilities related to telecommunications services in accordance with the present invention.

It will be appreciated by one having ordinary skill in the art that system components, modules, programs, etc. within system 100 may be distributed across and utilized the various network facilities within system 100. For example, system components may reside on application server facility 104, web server facility 106, and network client 114, as well as a database facility 108, a mail server 110, additional server facility 112, and telecommunications devices switch 116 and central office 118, and validation facility 120.

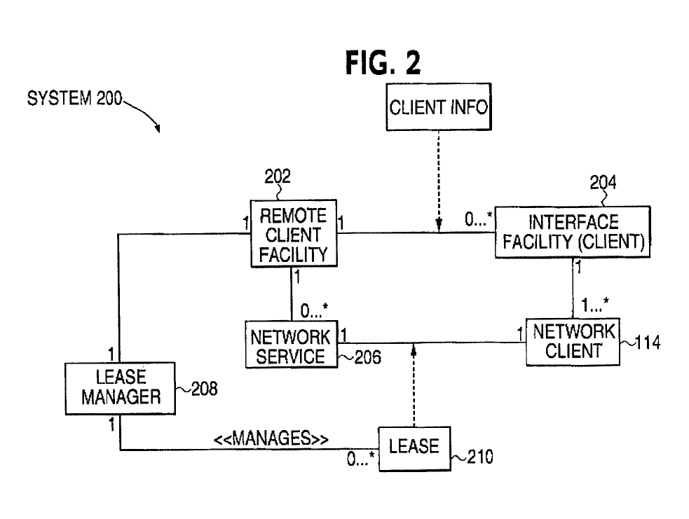

Referring now to FIG. 2, depicted therein is a logical diagram of an exemplary remote client manager and its system components that facilitate the management of remote clients and the delivery of applications thereto, within application server system 100 in accordance with a preferred embodiment of the present invention.

In particular, system 200 includes five basic components: a remote client facility 202, a network client 114, a interface facility 204, a lease manager 206, and a network service 208. Remote client facility 202, interface facility 204, and lease manager 206 work together to deliver and manage network service 208 (i.e., modular applications within the application framework, such as enhanced web applications, etc.) for network client 114.

Remote client facility 202 may be a computer module, JAVA program, applet, servlet, etc., configured to communicate to web server facility 106 (e.g., via JAVA RMI, HTTP, TCP/IP, etc.), to receive and process a request from network client 114, to register network client 114 (e.g., via a JAVA RMI registry), interface facility 204, and network service 206, to locate network service 206 based on the request and reference network client 114 to network service 206 in order to initiate or facilitate an application, such as an enhanced web application.

In a preferred embodiment of the present invention, remote client facility 202 is a JAVA based program residing on and continuously running in the memory of application server facility 104. It will be appreciated by one having ordinary skill in the art that remote client facility 202 may utilize system memory to maintain data in accordance with a preferred embodiment of the present invention, thereby facilitating delivery and execution of distributed applications across network 102 and the various facilities within the application server system 100.

Network service 206 is an application component or facility which wishes to make itself available to network clients, such as network client 114. Network service 206 may be any program or sub-program (e.g., C program, JAVA servant, etc.) that is stored and served on application server facility 104, web server facility 106, or any other accessible network facility within system 100, and is configured to access and control loaded application components and facilities (e.g., JAVA programs, servants, etc.) within system 100. The first step for a network service 206 to make itself available to network client 114 is to register itself with remote client facility 202. Remote client facility 202 maintains a list (for example, a table in database facility 108, an object in memory, etc.) of all registered network services. Upon registration, remote client facility 202 will assign network service 206 an unique Component ID, update it's registry (list) and export network service 206 on a specific port (e.g., logical or physical port, etc.) of the appropriate server facility (i.e., application server facility 104, web server facility 106, etc.), which thereby makes network service 206 available to network client 114.

Interface facility 204 may be any program, sub-program or object that is configured to be downloaded to network client 114, or be accessed by network client 114 via network 102 (e.g., via IP, JAVA RMI, etc.), and to interface (i.e., link, provide communication between, interpret messages for, translate commands, etc.) network client 114 with remote client facility 202. An exemplary interface facility is a JAVA program running within a JAVA Virtual Machine on a client PC, and is configured to interface JAVA objects within the same JVM with remote client facility 202 via JAVA RMI.

According to a preferred embodiment of the present invention, network client 114 may be a JAVA object (such as a JAVA applet running within a web browser, etc.) which wishes to obtain a reference to a network service, such as network service 206. The first step for network client 114 is to obtain a reference to the interface facility 204 which is running in the network client's JVM (JAVA virtual machine). Interface facility 204 makes contact with remote client facility 202 on a known server and port. Interface facility 204 will register itself with the remote client facility 202, at which point the following things happen: remote client facility 202 checks the IP address from which the request is coming (i.e., the IP address of network client 114 or the computer system on which network client 114 is being executed); optionally, the IP address is checked against an accept/deny list (security list). The accept/deny list makes it possible to deny clients coming from a specific IP address. An accept/deny list may be stored in a database object within database facility 108, in memory, or in a file, such as a text file named “iplist.txt”. Entries in the list can be prioritized, such as descending from highest priority to lowest. The following are sample entries in an accept/deny list, followed by a description of the entry:

+127.0.0.1 grants login permission to the specified IP address

−127.0.0.1 denies login permission to the specified IP address

+* grants login permission to all IP addresses

−* denies login permission to all IP addresses

Remote client facility 202 may attempt a callback on network client 114. A callback is a simple routine that a server makes on a client. The purpose of the callback is to see if future server-to-client method invocations will be allowed (e.g., a possible scenario of callbacks not being supported is if a client is behind a firewall which does not allow incoming requests). Whether or not callbacks are allowed is an attribute of network client 114, which is stored by remote client facility 202. Remote client facility 202 assigns network client 114 a Client ID, which uniquely identifies network client 114.

Once network client 114 is registered, it can request access to network service 206 (and any available network service) via interface facility 204. Interface facility 204 requests a network service by specifying the corresponding network service Component ID as well as a specific version of the same. In this case, the Component ID and version of network service 206 would be specified (multiple versions of a network service may exist and be available at the same time). Remote client facility 202 first checks to see that the requested Service is available, then checks to see if a compatible version number of the network service 206 is available (e.g., by checking the registry list in memory, in database facility 108, etc.). If a compatible version of the requested network service 206 is available, a reference to the network service 206 is returned to the network client 114.

If an additional network client from the same JVM wishes to request the use of the same or a different network service, the same interface facility 204 is used for communicating with remote client facility 202. Only one interface facility 204 exists per JVM, whereas multiple network clients may exist. Such an interface facility will facilitate the management of all clients within a JAVA Virtual Machine (JVM). An example of a JAVA applet that may be used as an interface facility according to a preferred embodiment of the present invention is listed below. The below listed computer code is copyright SIMPLIFIED TELESYS, INC., and may include trade secrets as well as other confidential and proprietary property of the same; all rights are reserved.

package com.simpletel.mum.client;

import com.simpletel.mum.daemon.remoteclient.Message;
import
com.simpletel.mum.daemon.remoteclient.RCD_ClientInterface;
import com.simpletel.mum.service.ServiceInterface;
import java.io.PrintStream;
import java.io.Serializable;
import java.net.MalformedURLException;
import java.net.URL;
import java.rmi.NoSuchObjectException;
import java.rmi.NotBoundException;
import java.rmi.RemoteException;
import java.rmi.RMISecurityManager;
import java.rmi.registry.LocateRegistry;
import java.rmi.registry.Registry;
import java.rmi.server.UnicastRemoteObject;
import java.util.HashMap;
import java.util.Iterator;
import java.util.Map;
import java.util.Set;
/**

*Singleton class which manages all clients for a

particular Java VM.

*

*/
final class ClientManager implements
ClientManagerInterface {

/** Whether or not SSL should be disabled. */
private static final boolean

disableSSL=Boolean.getBoolean (“com.simpletel.mum.disableSSL”);

/** The singleton reference to the client manager.

*/

private static ClientManager clientManager;
/** The output stream to which client manager

information is logged. */

private static PrintStream out;
/** Counter used to create unique client

identifiers. */

private volatile static int clientCounter=0;
/** The unique identifier of this client. */
public String clientID;
/** The interface to the RCD. */
private RCD_ClientInterface rcdInterface;
/** Maps client unique IDs to the services they use.

*/

private Map services=new HashMap ( );
/** References back to the clients that this object

is managing. */

private Map clients=new HashMap ( );
/** Does the client support callbacks? */
private boolean callbacks=false;
/**
* If the client does not support callbacks, this

thread will periodically check the

* RCD Message Queue for any messages intended for

the client; in addition, this

* Thread also renews the client's Leases.
*/
private Thread clientManagerThread;
/** The socket factory used to generate SSL RMI

sockets. */

private SecureRMISocketFactory socketFactory;
/**

* Creates a new ClientManager connected to the

server at the specified URL.

*
* @param mumHost the host where Chrysanthemum is

being run

* @param registryPort the server port which hosts

the RMI registry

* @param username the username of the user who

started this client manange.

* @param keyStoreURL the URL where the SSL key

store should be found.

* @param keyStorPassphrase the pass phrase to the

key store.

*
* @throws ClientException if an error occurs when

hooking up with the server.

* @throws RemoteException if a remote error occurs

when hooking up with the server.

*/

private ClientManager(final String mumHost,final int

registryPort, final String username,

final URL

keyStoreURL, final String keyStorPassphrase) throws
ClientException,

RemoteException

{

try {

if(System.getSecurityManager ( ) ==null) {

log(“CLIENT MANAGER: Setting

security manager to RMI security manager. . .”);

System.setSecurityManager(new

RMISecurityManager( ));

} // if
else {

log(“CLIENT MANAGER: Security

manager found.”);

}// else
if(!disableSSL) {

log(“CLIENT MANAGER: Instantiating

SSL socket factory. . .”);

socketFactory=new

SecureRMISocketFactory (keyStoreURL, keyStorPassphrase);

} // if

} // try
catch(final Exception e) {

throw new

ClientException(e.getMessage( ) , e);

} // catch
try {

log(“CLIENT MANAGER: Locating the

registry. . .”);

final Registry

registry=LocateRegistry.getRegistry(mumHost,registryPort);

log(“CLIENT MANAGER: Looking up the

RCD. . .”);

rcdInterface=(RCD_ClientInterface) registry. lookup (“RCD”);

{ // try
catch(NotBoundException nbe) {

throw new

ClientException(nbe.getMessage ( ) , nbe);

} // catch
// This thread renews Leases and checks for

client messages

//log(“CLIENT MANAGER: Creating client manager

thread. . .”);

clientManagerThread=new ClientThread ( );
// export this client manager to make it

available for callbacks

log(“CLIENT MANAGER: Exporting client

manager. . . ”);

if(disableSSL) {

UnicastRemoteObject.exportObject (this, 0);

} // if
else {

UnicastRemoteObject.exportObject (this, 0, socketFactory,

socketFactory);

} // else
// register the client with the rcd
log(“CLIENT MANAGER: Registering client

manager. . .”);

clientID=rcdInterface.registerClient(username,this);
} // ClientManager(String,int)
/**

* Logs a message to the print stream.
*
* @param text the text to log
*/

static final void log(final String text) {

if(out!=null) {

synchronized (out) {

out.println(text);

} // synchronized

} // if

} // void log(String)
/**

* Sets the print stream to which debug messages are

sent.

*
* @param a print stream.
*/

static final void setLogStream(final PrintStream ps)

{

if(out==null) {

out=ps;

} // if
else {

synchronized(out) {

out=ps;

} // synchronized

} // else

} // void setLogStream(PrintStream)
/**

* Returns the print stream to which debug messages

are sent.

*
* @return a print stream.

static final PrintStream getLogStream( ) {

return out;

} // PrintStream getLogStream( )
/**

* Returns the client's unique identifier;
*
* @return the client's unique identifier;

public String getClientID( ) {

return clientID;

} // String getClientID( )
/**

* Returns an instance of the client manager to

clients.

*
* @param serverHost the hostname of the server.
* @param registryPort the port where the server

should be found.

* @param username the username of the user who

started this client manange.

* @param keyStoreURL the URL where the SSL key

store should be found.

* @param keyStorPassphrase the pass phrase to the

key store.

*
* @return reference to this ClientManager
*
* @throws ClientException if an error occurs when

hooking up with the server.

* @throws RemoteException if a remote error occurs

when hooking up with the server.

*/

public synchronized static ClientManager

getInstance (final String username,final String serverHost,
final int registryPort,final URL keyStoreURL,
final String keyStorPassphrase) throws

ClientException,RemoteException {

if (clientManager==null) {

clientManager=new

ClientManager (serverHost,registryPort,username,keystoreURL,
keyStorPassphrase);

} // if
return clientManager;

} // ClientManager getInstance(String,int)
/**

* Attempts to contact the server to obtain the

usage of a Service.

*
* @param client reference back to this client
*
* @return ServiceInterface of the requested Service

ServiceInterface getServiceInterface (final Client

client) throws ClientException,RemoteException {

ServiceInterface serviceInterface=null;
// Export the client to make it available for

callbacks

log(“CLIENT MANAGER: Exporting

“+client.getComponentName( )+“. . .”);

if(disableSSL) {

UnicastRemoteObject.exportobject(client,0);

} // if
else {

UnicastRemoteObject.exportObject(client,0,socketFactory,

socketFactory);

} // else
// determine the unique id which will identify

the particular client

final String

id=clientID+“#”+(clientCounter++);

log(“CLIENT MANAGER: Client ID is “+id+”.”);
client.uniqueID=id;
log(“CLIENT MANAGER: Getting service interface

for service \grave{ }“+Client.getServiceComponentID( )+

”'version

“+client.getServiceVersionNumber( )+“.”+client.getServiceMa
jorRevisionNumber( ) +“.”);

serviceInterface=rcdInterface.requestService(client,

id,client.getServiceComponentID ( ),

client.getServiceVersionNumber ( ),
client.getServiceMajorRevisionNumber ( ));

// keep track of the clients in a map - key is

the unique id, object is reference to the client

clients.put(id,client);

services.put(id,client.getServiceComponentID( ));

log(“CLIENT MANAGER: Client registered.”);
return serviceInterface;

} // getServiceInterface
/**

* Notification by the Client to the server that it

is finished using a Service

*
* @param client the client that is no longer using

the Service

* @param dependancy information about the Service

the client no longer needs

*/
public void terminateService (Client client) {

try {

// Unexport the client
log(“CLIENT MANAGER: Unexporting

“+client.getComponentName( )+“. . .”);

UnicastRemoteObject.unexportObject(client,true);

} // try
catch(NoSuchObjectException e) {

System.out.println(“CLIENT MANAGER:

NoSuchObjectException unexporting client.
“+e.getMessage( ));

} // catch
clients.remove(client.getUniqueId( ));

services.remove(client.getServiceComponentID ( ));
} // terminateService
/**

* Test callback method invoked by the server upon

Client registration

public boolean SupportsCallbacks( ) {

log(“CLIENT MANAGER: Supporting callbacks!”);
return callbacks=true;

} // boolean supportsCallbacks( )
/**

* Invoked by the server to send a message to the

client. This is only invoked if the

* Client supports callbacks.
*
* @param The Message sent by the server.
*/

public void sendMessage(final Message m) {

log(“Received a message from the server:”);
log(“ Source: “+m.getSource ( ));
log(“ Destination: “+m.getDestination( ));
log(“ Message: “+m.getMessage( ))

} // void sendMessage (Message)
/**

* Thread that renews client Leases and checks for

messages.

*
*/

private final class ClientThread extends Thread {

/**

*Constructs the thread.
*/

public ClientThread( ) {

this.setName(“Client Manager Thread”);
this.setDaemon(true);
this start( );

} // ClientThread( )
/**

* The run method.
*/

public void run( ) {

Runtime rt=Runtime.getRuntime( );
while (rcdInterface!=null) {

try {

//log(“MEMORY REPORT: “+new

java.util.Date( )+” Free: “+rt.freeMemory( )+” Total:
“+rt.totalMemory( ));

Thread.sleep (60000); //

one minute

} // try
catch(InterruptedException ie) {

// do nothing special

here. . .

} // catch
try {

if(services.size( ) > 0) {

//log (“CLIENT THREAD:

Renewing leases. . .”);

rcdInterface.renewLeases(services);

} // if
// if the client does not

support callbacks, check the server message queue

// for messages intended for

this client

if(!callbacks) {

final Set

messageSet=rcdInterface.checkMessages(clientID);

if(!messageSet.isEmpty( )) {

// iterate

through the messageSet for the client's messages.

for(final

Iterator iter=messageSet.iterator( );iter.hasNext( );) {

sendMessage((Message)iter.next ( ));

} // for

} // if the client

got messages

} // if the client does

not support callbacks

} // try
catch(RemoteException e) {

// if a remote exception

occurs, bad things have happened. . .

log(“CLIENT MANAGER: Lost

connection to server!”);

e.printStackTrace(out);
// null out the interface
rcdInterface=null;

} // catch

} // while

} // void run( )

} // class ClientThread

} // class ClientManager

Lease manager 208 may be any program, sub-program, object, etc. or may be a portion of remote client facility 202, and is configured to manage the existing Leases within system 200 (and system 100). Lease management is the mechanism used by the remote client facility 202 to manage network clients usage of network services. A Lease is an object (e.g., a JAVA object, database object, file, etc.) used to represent the usage of a single network service by a single network client, such as network service 206 by network client 114. When the reference to a network service is returned to a network client after a successful request, a new Lease is created between the network client and the network service (e.g., a new object is created in memory corresponding to the reference, the network client, the network service, etc.). A Lease has an expiration time, therefore it is the responsibility of network client 114 to periodically renew its Lease(s). Network client 114 does this via interface facility 204. Interface facility 204 takes on the responsibility of renewing the Leases of the network clients which it manages. For example, when network client 114, through interface facility 204, obtains a reference to network facility 206, lease manager 208 creates a new Lease object corresponding to the reference.

Lease manager 208 is configured to perform the following tasks: (1) Create new Leases (lease objects). A new Lease is created whenever a network client successfully requests a network service. (2) Check for expired Leases. The amount of time between the checking of Leases is configurable via the according to requirements (e.g., leases may be monitored every 5 minutes, etc.). (3) Register Lease-Listeners (objects which listen for Lease-Events). A Lease-Listener is an object which is interested in receiving notification of Lease-Events. A Lease-Event is generated when one of two things occur: a new Lease is created; an expired Lease is removed. For example, network service 206 may be of a Lease-Listener. This means that network service 206 is notified every time a Lease on network service 206 is created. Network service 206 may be configured to perform any tasks necessary to accomplish its function when a new network client obtains a reference to it. (4) Remove expired Leases. If network client 114 does not renew it's Lease on a network service 206, eventually the Lease will expire and the reference will be terminated (i.e., network client 114 will lose access to network service 206).

In a preferred embodiment of the present invention, all communication between network client 114 and network service 206 is done via the JAVA RMI (Remote Method Invocation) protocol, however other protocols may be used (e.g., TCP/IP, etc.). Secure socket communication is available using SSL (Secure Sockets Layer). SSL is used by default, however this feature may be turned off to increase performance.

Additional system components may be necessary to facilitate the present invention.

A network daemon (not shown) may be added to open and manage TCP/ID sockets (open, lock, send and receive messages, unlock, close connections, etc.). A network daemon can, for example, be a JAVA program, servlet, servant, etc. that tracks attributes that define a connection or socket. Such attributes may be the socket name, description, ID, host name (name of the host connected to the socket), IP address of the host, remote port of the connection, local port of the connection, lock object (the object locking the socket), and Listeners (a list of objects that notify when events occur). Accordingly, network daemon may be utilized within system 200 (and system 100) to facilitate communication and messaging between system components and facilities as already described above.

A time toolkit daemon (not shown) may be incorporated into system 200 in order to provide valuable time functions to the remote client facility 202 or lease manager 208. A time toolkit daemon may simply be a JAVA program, servlet, servant, etc. that provides timer functions for keeping track of leases, connections, etc.

Accordingly, it will be readily appreciated by one having ordinary skill in the art, that system 100's modular, extendible design allows for the addition or modification of unlimited system components to enhance server capabilities, and that the powerful remote client manager system 200 allows remote clients to utilize and access unlimited network facilities and application components that are distributed across network 102. According, the present invention provides many valuable improvements such as improved sharing and maintainability. Literally, within system 100 (and system 200) any software object (e.g., JAVA object, etc.) residing within any system component within the framework may be a network client 114 and can obtain a reference to any other software object (e.g., JAVA object, etc.) within the framework.

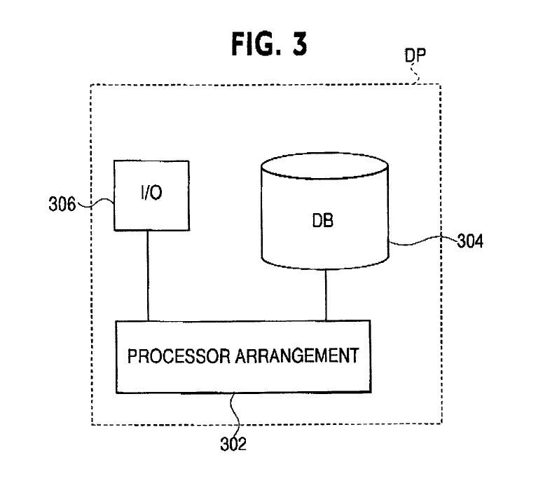

Referring now to FIG. 3, depicted therein is a block diagram of a computing system which may be used to implement server facilities, database facilities, remote client facilities, network facilities and network client facilities, to execute programs, API's, applets, utilities and other system components, etc. as described above with regard to FIGS. 1 and 2 in accordance with a preferred embodiment of the present invention. In particular, FIG. 3 depicts a data processing system DP which further includes a processor arrangement 302 including one or more processing elements, a data storage subsystem 304, an IO facility 306. The arrangement of these structures shown with data processing system DP will be immediately understood by those skilled in the art.

Data processing system DP is configured to receive and transmit data to and from network facilities and devices, customer systems, vendor systems, etc. via protocols such as TCP/IP, HTTP, JAVA RMI, etc., execute compilers, runtime engines, API's, operating, design facilities, designers, editors, and web server systems necessary to facilitate the present invention.

Data storage subsystem 304 as shown within data processing system DP, will include database objects, tables, columns, extents, etc. necessary to facilitate the present invention. Accordingly, data storage subsystem 304 may be configured to store data in files, flash memory, etc.

### Operational Aspects of the Present Invention

Described next are methods for managing remote clients within an extendible, distributed application server system and facilitating the delivery of distributed applications, such as enhanced web applications, across an electronic data network.

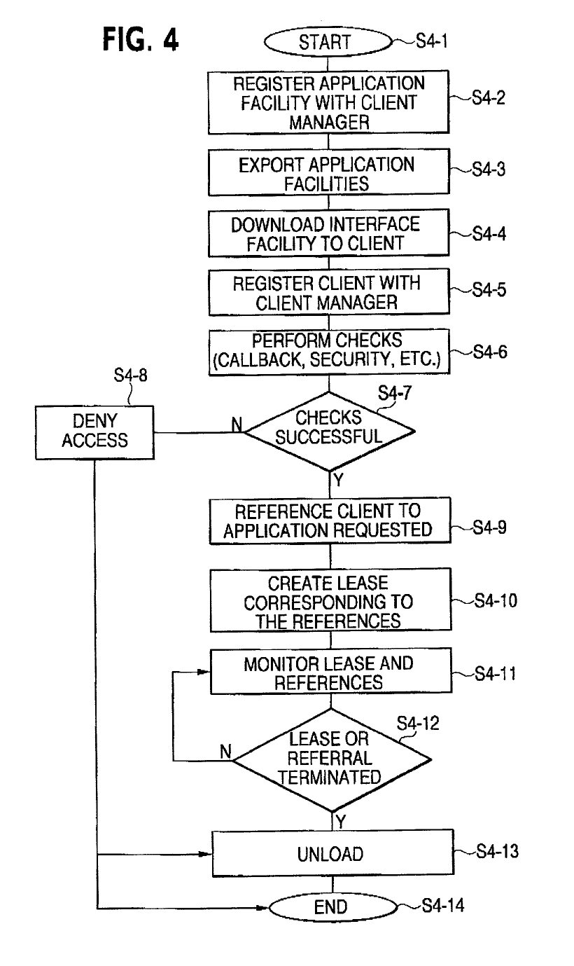

Referring now to FIG. 4, depicted therein is a flow chart of a method for managing remote clients within an extendible, distributed application framework via an electronic data network in accordance with a preferred embodiment of the present invention. In particular, processing begins at step S4-1 and immediately proceeds to step S4-2.

At step S4-2, application facilities (e.g., enhanced web application modules or components, etc.) that are meant to be available to network clients (such as network client 114 already described above with reference to FIGS. 1 and 2) are registered with a client manager. Application facilities may be JAVA programs, etc. that are to be served by the application server system and reside within the framework of the same; and, the client manager may be remote client facility 202 already shown and described above with reference to FIGS. 1 and 2. The registration may be done through standard JAVA as already described above with reference to FIG. 2, and will be readily understood by one having ordinary skill in the art. Once application facilities are registered with the client manager, processing proceeds next to step S4-3.

At step S4-3, the client manager makes the registered application facilities available for network clients. As already described above with respect to FIG. 2, the client manager may do this by exporting an application facility to a port of the server facility on which it resides. Processing proceeds next to step S4-4.

At step S4-4, a client web browser initiates an application by accessing a URL via the Internet and WWW (or other network) and downloads a web page. In a preferred embodiment of the present invention, the web page includes an interface facility, such as interface facility 202 already described above with reference to FIG. 2, which may be a JAVA applet, which is executed within the web browser. The client web browser is configured as already described above with reference to network client 114. As already described above, a network client may be a web browser, a JAVA object or other program; accordingly, a JAVA object which may act as network client 114 may also be packaged and downloaded together with interface facility (such as in a JAR file) to be executed within a web browser. Processing proceeds next to step S4-5.

Next, at step S4-5, the interface facility registers itself with the client manager, such as via JAVA RMI, and has already been described above with reference to FIG. 2, and will be readily understood by one having ordinary skill in the art. Processing proceeds next to step S4-6.

At step S4-6, the client manager performs checks, such as security checks, call-backs, etc against the network client. Such security checks may be performed as already described above with reference to FIG. 2. Processing proceeds next to step S4-7.

At step S4-7, if the checks performed at step S4-6 were successful, processing proceeds to step S4-9, otherwise, processing proceeds to step S4-8. It will be readily understood that many checks may be made prior to delivering an application to a network client, and what checks to be performed and how to measure whether checks have be successful or not, may be determined according to requirements.

At step S4-8, network clients is denied access; the network client is unregistered by the client manager; and, the network client is disconnected from the server. Processing proceeds next to step S4-13.

At step S4-9, once the network client is registered, it can request access all network services available via the client manager. This may be done as already described above with reference to FIG. 2. If a network service is available, the client manager references the network client to the network service. Processing proceeds next to step S4-10.

At step S4-10, a lease is created corresponding to the application reference made between the network client and the network service remote client in step S4-9. Such a lease may be a JAVA object containing data related to the reference, the client (and/or the interface facility running within the client's web browser) and the application facility, and may also contain time data, such as an expiration time. The lease may be created by a lease manager (such as lease manager 210 described above) residing on the server system, the client, or the web server, such as already described above with reference to FIG. 2. Optionally, leas-listeners may be informed regarding the creation of the lease as described above with reference to FIG. 2. Processing proceeds next to step S4-11.

At step S4-11, the lease is monitored for events. The lease may be monitored by a lease manager such as already described above with reference to FIG. 2. Processing proceeds next to step S4-12.

At step S4-12, if the lease is terminated or if the reference has been terminated (e.g., the client is dropped, shutdown, etc.) then processing proceeds to step S4-13. Optionally, leas-listeners may be informed regarding the termination of the lease as described above with reference to FIG. 2. Otherwise, processing returns to step S4-11.

At step S4-13, all unnecessary objects (e.g., JAVA objects, data objects, etc.) are unloaded from memory, data is cleaned up (e.g., any files or database objects may be modified or deleted), etc., and processing proceeds to step S4-14.

At step S4-14 processing is terminated.

Thus, having fully described the present invention by way of example with reference to the attached drawing figures, it will be readily appreciated that described above are methods for managing individual components of an application server system and the applications that are served thereby. It will be appreciated that the methods described above are merely exemplary and that the present invention is not limited thereto; and, that the modular framework described above with reference to FIGS. 1 and 2 is extremely powerful and allows for many modifications and enhancements.

Additionally, user session data may be maintained through standard programming practices, such as creating an object that contains all user session data, and updating the object during the various stages of processing (e.g., passing the object, etc.).

Additionally, group permission and security may be similarly handled with standard security methods. Permissions may be stored in an object, DBA tables, customized database objects, etc., and maintained during the various stages of processing.

Accordingly, it will be understood by one having ordinary skill in the art that multiple, customized and localized web interfaces may be dynamically generated in response to a request, and in real-time, while standardizing the underlying data and content to be delivered.

What is claimed is:

1. A remote client manager that facilitates an extendible, modular application server system distributed via an electronic data network, comprising:
a network client configured to access said application server system via said electronic data network and to download and execute an interface facility, said interface facility configured to facilitate the delivery of an application facility from said application server system;
a remote client facility configured to communicate with said network client, said interface facility, and said application facility, to register said network client, said interface facility, and said application facility, to receive an application request from said interface facility via said electronic data network related to said application facility, and to reference said network client to said application facility to facilitate the delivery of said application facility to said client; and
a lease manager configured to create a lease corresponding to said reference and to terminate said lease when a time interval related to said lease expires.

2. The system according to claim 1, wherein said remote client facility is further configured to select a specific revision of said application facility based on said interface facility.

3. The system according to claim 1 wherein said interface facility is a JAVA object and said application facility is a subclass of a JAVA program.

4. The system according to claim 1, wherein said network client is configured to execute said application facility via said electronic data network via JAVA RMI after said network client receives said reference.

5. The system according to claim 1, wherein said network client is a web browser and said electronic data network is the Internet and World Wide Web.

6. The system according to claim 1, wherein said application facility is a JAVA object.

7. The system according to claim 1, wherein said network client is a JAVA object running within a web browser.

8. The system according to claim 1, wherein said interface facility continually renews said lease until said interface facility is terminated by said network client.

9. A method for managing a remote network client within an extendible, modular application server system distributed via an electronic data network, comprising the steps of:
at a remote client manager residing on a server facility, registering an application facility and assigning said application facility a first unique identifier;
at said remote client manager, exporting said application facility to a port of said server facility;
at said remote network client, accessing said server facility to download and execute an interface facility, said interface facility configured to communicate with said remote client manager;
at said interface facility, registering with said remote client manager and requesting said application facility;
at said remote client manager, checking an IP address related to said remote network client against a secure client list and performing a call back to said remote network client;
at said remote client manager, if said call back is successful, assigning a second unique identifier to said remote network client and creating a reference from said remote network client to said application facility based on said first and second unique identifiers;
at a lease manager residing on said server facility, creating a lease object having an expiration related to said reference; and,
at said lease manager, monitoring said lease object and terminating said reference at the expiration of said lease object.

10. The method according to claim 9, wherein said remote client manager is further configured to select a specific revision of said application facility based on said interface facility.

11. The method according to claim 9 wherein said interface facility is a JAVA object and said application facility is a subclass of a JAVA program.

12. The method according to claim 9, wherein said remote network client is configured to execute said application facility via said electronic data network via JAVA RMI after said network client receives said reference.

13. The method according to claim 9, wherein said remote network client is a web browser and said electronic data network is the Internet and World Wide Web.

14. The method according to claim 9, wherein said application facility is a JAVA object.

15. The method according to claim 9, wherein said remote network client is JAVA object executing within a web browser.

16. The method according to claim 9, wherein said interface facility continually renews said lease until said interface facility is terminated by said network client.

17. A remote client manager that facilitates an extendible, modular application server system configured to serve a distributed software application via an electronic data network, comprising:
at least one application facilities when executed delivers said distributed software application;
a web browser client configured to access said application server system via said electronic data network and to download and execute an interface facility and a network client, said interface facility configured to facilitate communication and control between said network client and said at least one application facility via said electronic data network;
a remote client facility configured to communicate with said network client, said interface facility, and said at least one application facility, to register said network client, said interface facility, and said application facility, to receive an application request from said interface facility via said electronic data network related to said application facility, and to reference said interface facility to said application facility to facilitate the delivery of said distributed software application to said network client; and
a lease manager configured to create a lease corresponding to said reference and to terminate said lease when a time interval related to said lease expires.

18. The system according to claim 17, wherein said remote client facility is further configured to select a specific revision of said application facility based on said interface facility.

19. The system according to claim 17, wherein said interface facility is a JAVA object and said application facility is a subclass of a JAVA program.

20. The system according to claim 17, wherein said network client is configured to execute said application facility via said electronic data network via JAVA RMI after said network client receives said reference.

21. The system according to claim 17, wherein said at least one application facility is a JAVA object.

22. The system according to claim 17, wherein said network client is a JAVA object, said interface facility is a JAVA object, and said network client and said interface facility are packaged in a JAR file.

23. The system according to claim 17, wherein said interface facility continually renews said lease until said interface facility is terminated by said network client.
